(19) United States
(12) Patent Application Publication
(10) Pub. No.: US 2024/0105206 A1
(43) Pub. Date: Mar. 28, 2024

(54) SEAMLESS CUSTOMIZATION OF MACHINE LEARNING MODELS

(71) Applicant: QUALCOMM Incorporated, San Diego, CA (US)

(72) Inventors: Hesu HUANG, San Diego, CA (US); Leonid SHEYNBLAT, Hillsborough, CA (US); Vinesh SUKUMAR, Fremont, CA (US); Ziad ASGHAR, San Diego, CA (US); Joel LINSKY, San Diego, CA (US); Justin MCGLOIN, Los Altos, CA (US); Tong TANG, Escondido, CA (US)

(21) Appl. No.: 17/934,833

(22) Filed: Sep. 23, 2022

(51) Int. Cl. G10L 25/60; G10L 15/06; G10L 15/08

(52) U.S. Cl. CPC G10L 25/60; G10L 15/063; G10L 15/08; G10L 2015/0635; G10L 2015/088

(57) ABSTRACT

Certain aspects of the present disclosure provide techniques and apparatus for improved machine learning. Voice data from a first user is received. In response to determining that the voice data includes an utterance of a defined keyword, a user verification score is generated by processing the voice data using a first user verification machine learning (ML) model, and a quality of the voice data is determined. In response to determining that the user verification score and determined quality satisfy one or more defined criteria, a second user verification ML model is updated based on the voice data.

### INTRODUCTION

Aspects of the present disclosure relate to machine learning. Machine learning architectures have been used to provide solutions for a wide variety of computational problems. Training machine learning models to perform accurately and reliably typically requires vast amounts of data (as well as significant computational resources) which are often not available in common deployment systems (e.g., on an end-user's smartphone). Moreover, in many solutions, some level of user-customization (e.g., training the model using data specific to the end user, such that each user has a corresponding personalized model) is desirable for improved model performance. However, such customization requires personalized data for each user, and conventional approaches generally require that the user provide substantial manual effort, as well as bearing significant computational expense, to enable the model customization.

### BRIEF SUMMARY

Certain aspects provide a processor-implemented method for training a machine learning model for user verification, comprising: receiving voice data from a first user; in response to determining that the voice data includes an utterance of a defined keyword: generating a user verification score by processing the voice data using a first user verification machine learning (ML) model; and determining a quality of the voice data; and in response to determining that the user verification score and determined quality satisfy one or more defined criteria, updating a second user verification ML model based on the voice data.

Certain aspects provide a processor-implemented method for performing user verification using machine learning, comprising: receiving voice data from a first user; in response to determining that the voice data includes an utterance of a defined keyword: generating a user verification score by processing the voice data using a first user verification machine learning (ML) model; and determining a quality of the voice data; and in response to determining that the user verification score and determined quality satisfy one or more defined criteria, storing the voice data as a training exemplar

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for seamless updating of machine learning models and/or training and refining new models without the need for manual user re-enrollment.

FIG. 2 depicts an example workflow for continuous learning for machine learning models.

FIG. 3 depicts an example workflow for improved federated learning for machine learning models.

FIG. 4 is a flow diagram depicting an example method for seamless updating of machine learning models.

FIG. 5 is a flow diagram depicting an example method for continuous learning for machine learning models.

FIG. 6 is a flow diagram depicting an example method for improved federated learning for machine learning models.

FIG. 7 is a flow diagram depicting an example method for updating user verification models.

FIG. 8 is a flow diagram depicting an example method for evaluating voice data for improved machine learning.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning model customization.

In some aspects, user data can be collected and automatically evaluated and verified to provide seamless model updating and continuous learning in a way that improves the model performance (e.g., resulting in improved customization and therefore model accuracy), reduced manual effort (e.g., because users need not perform the data collection, verification, or labeling), reduced computational expense (e.g., because only validated and high-quality data is stored, while the remaining data can be immediately and automatically discarded), and general improved functionality of the computing systems.

In some examples discussed herein, user voice verification is used as one technical problem that can be solved using customized machine learning models trained and refined using aspects of the present disclosure. However, aspects of the present disclosure are readily applicable to a wide variety of model training and refinement scenarios, including for other user customization (e.g., facial recognition for specific users), as well as general non-customized training and refinement (e.g., general collection and validation of data for a variety of machine learning purposes).

In some aspects, machine learning models are used to validate or verify voice, gesture, or other sensory-based commands to detect user input or otherwise initiate various actions. For example, trained models may be used to authenticate a user based on their voice, prior to allowing the user to make further requests or commands (e.g., to unlock a smartphone, or to modify data).

In many cases, this verification and/or keyword detection is performed using one or more global generic models (e.g., trained to recognize keywords using voice data from a wide variety of users), where the global model(s) may further be refined or fine-tuned for specific users. Though this can provide sufficient data to train the model (which may otherwise be unavailable if limited to data from specific users), these global models can often erroneously respond due to a variety of challenges, including the user's dialect, pitch, and the like. For example, a global model may activate or validate voice data that does not actually include a defined keyword or utterances that were not actually spoken by the authorized user. Similarly, the global model may fail to identify or validate voice data that does have the indicated keyword and/or is spoken by the authorized user.

User-based customization can therefore significantly improve the accuracy of these models. In conventional approaches, the user is generally required to explicitly provide the necessary user data to enable such customization. For example, the user may be prompted to repeat a keyword or phrase several times (e.g., as a model or user enrollment step, where the model is refined or fine-tuned for the specific user), allowing the system to refine the global model for the specific user's voice data. However, this existing customization is unwieldy and time-consuming. Further, because it requires manual effort from the user, conventional approaches cannot realistically deploy frequent model or architecture updates, as users would be required to repeatedly perform such enrollment. This reduces the performance of the models and system, as model changes cannot be implemented at will or at scale.

Aspects of the present disclosure can provide improved and automated data validation and model training to enable such seamless training and customization. In some aspects, these processes are referred to as “seamless” to indicate that they can be performed (e.g., a new model can be deployed) without manual effort on the part of the user (and, in some aspects, without the user even being aware that a new model is being deployed). In some aspects, a currently-deployed model (e.g., the verification model that is currently used to validate the voice data) is used to enable automated collection of new exemplars, which can then be used to refine or fine-tune new model(s) for the user. In some aspects, the user device can continue to extract user utterances post-enrollment, and store these utterances in local storage on the device. This can be used as labelled training data, and user privacy can be maintained by refraining from transmitting the data to any other devices and/or retaining the data locally (e.g., it may be used locally, without leaving the registered device).

In some aspects, after a sufficient quantity of good quality samples (e.g., greater than 200) is collected, backpropagation or model training can be performed such that the new model(s) may be updated and accuracy can be improved. Using aspects of the present disclosure, during such continuous learning, no re-enrollment is needed and training can be performed on the user device (if sufficient computational resources are available) or shared with a local or remote host, as explained in more detail below.

### Example Workflow for Seamless Updating of Machine Learning Models

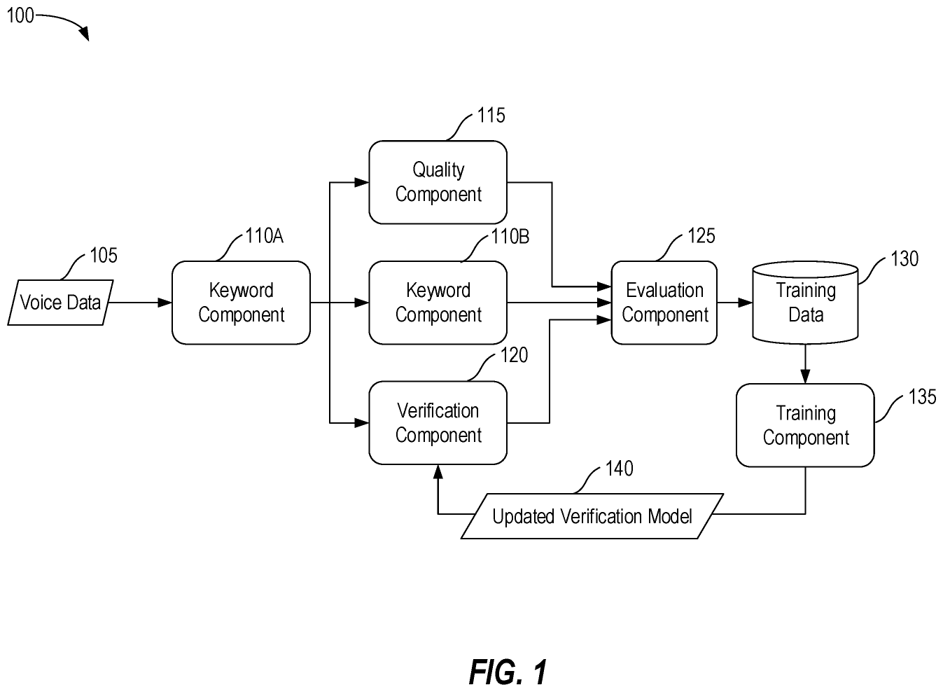

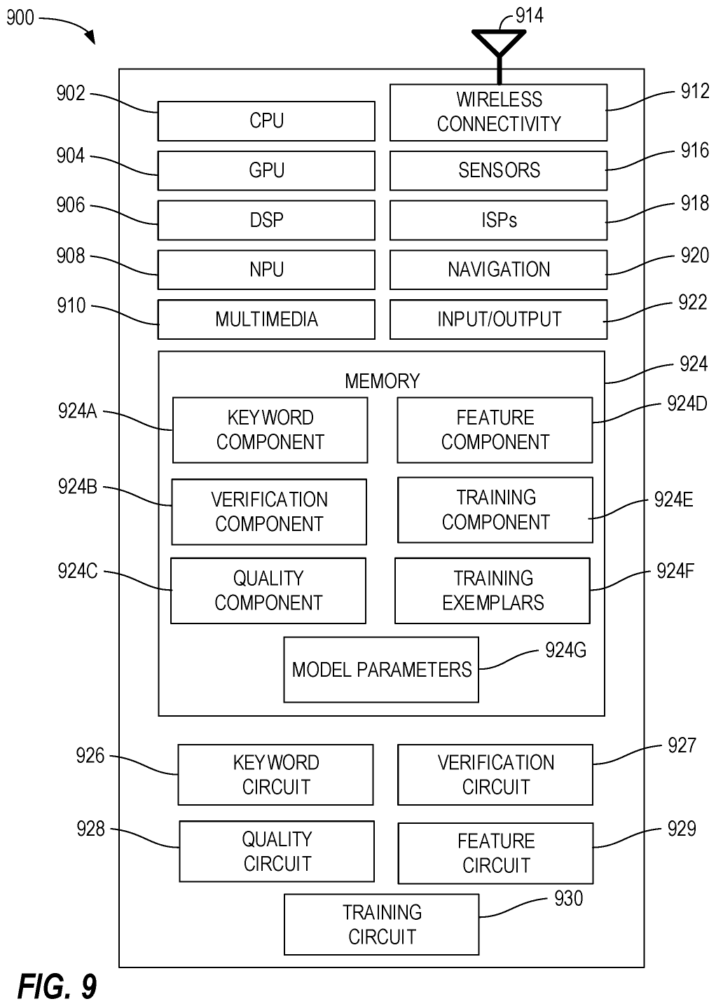

FIG. 1 depicts an example workflow 100 for seamless updating of machine learning models and/or training and refining models without the need for manual user re-enrollment. As used herein, the term “training” may generally be used interchangeably with other terms such as refining, fine-tuning, updating, and the like. In the illustrated example, the workflow 100 can be used for training or enrollment for user verification using voice data. However, as discussed above, aspects of the present disclosure are readily applicable to a wide variety of machine learning tasks. In some aspects, the workflow 100 is performed by an edge device (also referred to as an end device or user device), such as a smartphone, a smart watch, a laptop, a smart speaker or digital assistant, and the like. In at least one aspect, the workflow 100 is performed by a computing system such as the processing system 900 described below with reference to FIG. 9.

In the illustrated workflow 100, voice data 105 is received and evaluated by a keyword component 110A. The voice data 105 generally corresponds to audio data, which may be received from a microphone (and corresponding audio processing systems or components) or other components or sources. In aspects, the voice data 105 may include audio data formatted in a variety of formats, such as in a pulse-code modulation (PCM) format, in a Mel-frequency Cepstral Coefficients (MFCC) format, and the like. Although labeled as voice data 105, in some aspects, the input data may not actually include a user's voice. For example, the voice data 105 may be an audio recording that is being evaluated in order to determine whether it contains a user's voice at all, whether the voice contains an utterance of one or more keywords or phrases, whether the utterance was made by an authorized user, and the like.

In an aspect, the keyword component 110A may be used to provide a first-stage or initial processing of the voice data 105. In some aspects, the keyword component 110A may correspond to or use a lightweight algorithm or machine learning model that has a relatively small memory footprint and/or low computational burden, as compared to more robust models. For example, the keyword component 110A may be used to perform an initial evaluation of voice data 105 as it is collected (e.g., continuously as it is recorded by a user device) in order to determine whether the voice data 105 includes an utterance of one or more defined keywords or phrases.

In one aspect, the keyword component 110A can generate a binary output indicating whether the voice data 105 includes an utterance of a keyword or phrase. As used herein, a “keyword” may include a single word, multiple words, a phrase, and the like. In some aspects, the keyword component 110A generates a continuous value (e.g., between zero and one) indicating a probability or likelihood that the voice data 105 includes an utterance of a keyword or phrase. In one such aspects, the output score can be compared against one or more thresholds to determine whether to initiate downstream processing (e.g., where the voice data 105 may be discarded if the score is less than a threshold, such as 0.7).

In some aspects, because the keyword component 110A is lightweight, it can be used to efficiently process this significant volume of data in order to determine whether additional downstream processing (e.g., by the keyword component 110B) should be performed. That is, the keyword component 110A may generally require fewer computational resources, as compared to the keyword component 110B or other components. Thus, the keyword component 110A can be effectively used to reduce the overall computational needs of the system, as the (more robust) downstream processing is only selectively performed, rather than performed for all incoming voice data 105.

In some aspects, the keyword component 110A uses a machine learning model to identify defined keywords that are shared across all users. That is, the keyword component 110A may be used to detect a set of one or more specific keywords defined, during training, and used by any user and device that uses the model. In other aspects, the keyword component 110A may additionally or alternatively use machine learning models to identify or detect custom keywords or phrases (e.g., selected by each individual user).

In an aspect, if the keyword component 110A does not detect an utterance of the keyword(s) or phrase(s) in the voice data 105, then the data is discarded. In the illustrated workflow 100, if the keyword component 110A does detect an utterance of a keyword or phrase, then the voice data 105 is passed to a set of downstream components, including a quality component 115, a keyword component 110B, and a verification component 120.

The keyword component 110B may generally use machine learning models to perform similar analysis and functionality (e.g., keyword detection/identification in voice data 105) as the keyword component 110A. In an aspect, however, the keyword component 110B may use a more robust model (e.g., a model having more trainable parameters, layers, etc.) or algorithm having relatively higher computational expense, as compared to the keyword component 110A. Because the keyword component 110B is only used to evaluate the voice data 105 once it is validated by the keyword component 110A, this additional computational expense imposes a lower burden on the system, as compared to if it was used for all voice data 105. The keyword component 110B is generally more accurate than keyword component 110A, thus producing fewer false positives and/or false negatives.

The keyword component 110B is generally used to validate or verify the output of the keyword component 110A. For example, the keyword component 110B may similarly use machine learning models to attempt to identify or detect an utterance of one or more keywords or phrases (which may be static or user defined). As discussed above, the keyword component 110B may output a binary indication and/or a continuous score indicating whether the voice data 105 includes a keyword utterance.

In the illustrated workflow 100, the quality component 115 is used to evaluate the quality of the voice data 105. For example, the quality component 115 may evaluate the voice data 105 to determine whether it includes clipping (e.g., where portions of the audio were clipped, such as due to the volume or magnitude of the waveform exceeding a threshold), what the signal-to-noise ratio (SNR) of the voice data 105 (e.g., indicating the level of background noise in the audio data), the duration of the voice data 105, whether the voice data 105 includes distortion, the keyword ratio in the voice data 105 (e.g., the percentage of the voice data 105 that corresponds to the keyword, as compared to non-keyword audio), and the like.

In an aspect, the quality component 115 (or evaluation component 125, discussed in more detail below) can evaluate these metrics to determine whether the voice data 105 has sufficient quality. For example, the system may determine the number of samples or portions of the voice data 105 that include clipping, and determine whether this number or percentage is less than a threshold. Similarly, the system may determine whether the SNR meets or exceeds a minimum threshold (e.g., 12 dB), whether the duration meets or exceeds a minimum length of time, whether the distortion is below a defined threshold, whether the keyword ratio meets or exceeds a threshold, and the like.

In some aspects, the quality component 115 and/or evaluation component 125 performs this analysis and generates an overall quality score (e.g., a continuous value indicating the quality of the voice data 105) and/or a binary value indicating whether it is sufficiently-high quality. For example, the quality component 115 may determine that the quality is sufficient only if none of the individual thresholds or criteria are violated, only if fewer than a defined number of them are violated (e.g., if the duration is short, but all other quality criteria are met), and the like.

In an aspect, the verification component 120 can be used to provide user verification based on the voice data 105. For example, the verification component 120 may use a user verification or voice machine learning model to determine whether the voice data 105 includes the voice of an authorized user (e.g., the owner or user of the device on which the system operates), as opposed to a non-authorized user. In some aspects, as discussed above, the verification component 120 uses a customized or personalized model (e.g., a global model that has been fine-tuned or refined using voice data from the authorized user(s)). In some aspects, the verification component 120 can generate a binary value indicating whether the voice data 105 includes speech by the authorized user(s), a continuous value indicating a confidence that the voice data 105 includes speech from the authorized user(s), and the like.

In the illustrated workflow 100, the scores or other data generated by the quality component 115, keyword component 110B, and verification component 120 are provided to an evaluation component 125. Although depicted as a discrete component for conceptual clarity, in some aspects, the operations of the evaluation component 125 may be implemented by one or more other components, such as within the quality component 115, keyword component 110B, and/or verification component 120.

In an aspect, the evaluation component 125 can compare the generated scores or other data to confirm whether defined criteria (e.g., minimum and/or maximum thresholds) are satisfied. For example, as discussed above, the evaluation component 125 may confirm that the quality score (or values for the underlying quality metrics) meet defined criteria, that the confidence or probability generated by the keyword component 110B and/or verification component 120 meet or exceed defined thresholds, and the like.

In some aspects, the system can use relatively higher thresholds for some of the scores, as compared to typical use. For example, during typical (e.g., non-training) use, the system may use a default minimum value for the keyword score (generated by the keyword component 110B) and/or the user verification score (generated by the verification component 120). If the voice data 105 satisfies these default thresholds, then the system can proceed normally (e.g., to unlock the user device, retrieve requested data, and the like).

In some aspects, however, for the purposes of collecting and validating data for automated training or fine-tuning, the system can use relatively higher thresholds. For example, during ordinary use, the system may accept a keyword score of 0.8 for ordinary purposes, while declining to use the data as a training exemplar unless it has a keyword score of 0.9 or greater. In aspects, the particular thresholds used for each score may vary depending on the particular implementation. If higher thresholds are used, then the system can ensure that the models are only trained (or re-trained) on data that has a higher probability of the (automatically-generated) label being accurate.

In some aspects, if the voice data 105 fails to satisfy any of the criteria (e.g., because the quality score is below a threshold, or because the user verification score is below a threshold), then the evaluation component 125 can determine that the voice data 105 is not sufficient for training (even if it is otherwise sufficient for ordinary purposes, such as unlocking the device). The voice data 105 can therefore be discarded.

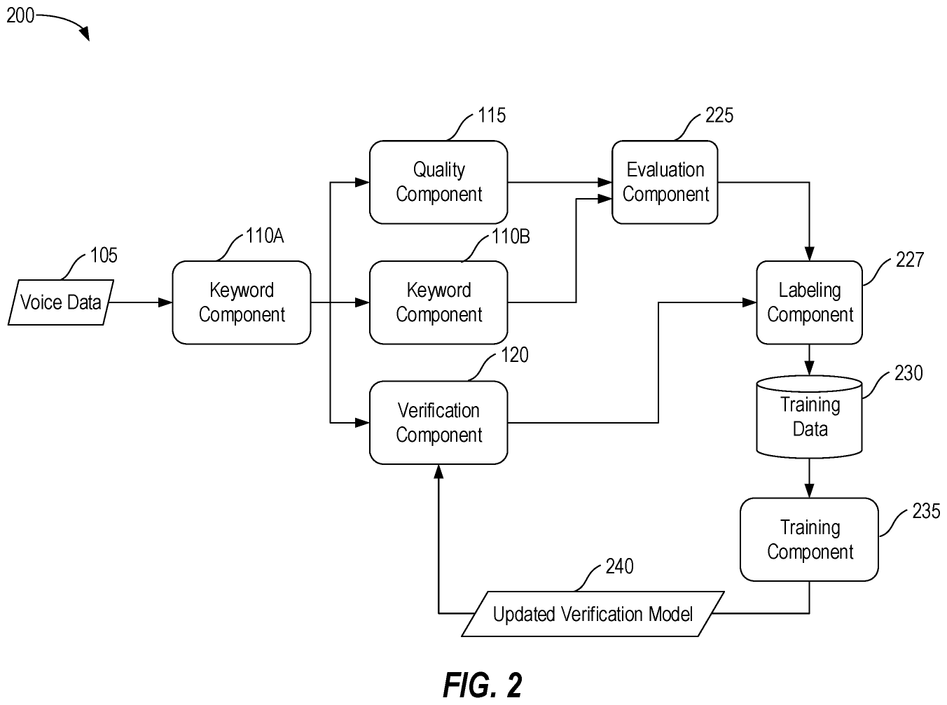

As illustrated, of the evaluation component 125 determines that the voice data 105 satisfies the criteria, the voice data 105 is stored in a repository for training data 130. This repository may be located locally within the user device, remotely on another user device, and/or remotely on a shared device (such as in the cloud). In some aspects, the training data 130 includes the voice data 105 itself (e.g., the PCM or MFCC data). In some aspects, the training data 130 includes extracted features of the voice data 105 (e.g., extracted by a feature extractor, not depicted in the illustrated example), as discussed in more detail below with reference to FIG. 2.

In an aspect, once the training data 130 satisfies defined criteria, the training component 135 can use it to generate an updated verification model 140. For example, once the training data 130 includes a minimum number of exemplars (e.g., five), the training component 135 can use the stored voice data 105 (which is known to belong to the user with sufficiently high confidence, as well as to recite the keyword(s) with sufficiently high confidence and to have sufficiently high quality) to refine, fine-tune, or otherwise train or update a user verification machine learning model.

In some aspects, to refine the model, the training component 135 processes the voice data 105 (or extracted features therefrom) to generate an output score (e.g., indicating a probability or confidence that the voice data 105 belongs to the authorized user). This score can then be compared against the known ground-truth (e.g., the fact that the voice data 105 did, in fact, come from the user), and the difference between the generated score and the ground-truth can be used to refine or update one or more parameters of the user verification model.

In an aspect, the updated verification model 140 may include an updated or refined version of the model currently in use by the verification component 120, an updated architecture, an entirely new model or architecture, and the like. For example, the updated verification model 140 may be the same architecture as the currently-used model, but with refined parameters based on the fine-tuning and/or based on additional global training. Similarly, the updated verification model 140 may have the same architecture, but with updated hyperparameters. As another example, the updated verification model 140 may be an entirely new architecture.

In the illustrated example, the updated verification model 140 can then be deployed/instantiated by the verification component 120 to process new voice data 105. In this way, the system can bring new models online seamlessly and without downtime or manual re-enrollment, thereby improving the accuracy and efficiency of the system.

Using the workflow 100, during ordinary use, the system can collect, validate, and store voice data 105 that is acceptable for training (e.g., for customizing a global model) for the specific user. This can allow the system to seamlessly introduce updated or entirely new model architectures and instances (e.g., models having the same architecture, but with updated parameters) without requiring laborious re-enrollment. Additionally, the system need not store or otherwise maintain the training exemplars between such re-trainings, thereby reducing the storage footprint of the system. That is, other than when a new model is being introduced, the system need not store the original enrollment exemplars (or any other voice data). This reduces the long-term storage requirements. Further, because the exemplars may be deleted (or otherwise archived to secure storage locations) after the re-training, the memory or storage needs are relatively short-term and limited, and the user's privacy is enhanced.

### Example Workflow for Continuous Learning for Machine Learning Models

FIG. 2 depicts an example workflow 200 for continuous learning for machine learning models. As used herein, continuous learning refers to the ongoing process of learning (e.g., updating model parameters) based on input data during runtime, allowing the system to learn using ever-increasing amounts of data and continuously updated data that may reflect the current environment or exogenous factors more accurately than the original training data.

In the illustrated example, the workflow 200 can be used for continuous learning or refinement of user verification models using voice data. However, as discussed above, aspects of the present disclosure are readily applicable to a wide variety of machine learning tasks. In some aspects, the workflow 200 is performed by an edge device (also referred to as an end device or user device), such as a smartphone, a smart watch, a laptop, a smart speaker or digital assistant, and the like.

In some aspects, the workflow 200 shares similarities with the workflow 100 of FIG. 1. As discussed above and in more detail below, the workflow 100 can be used to generate positive exemplars (e.g., voice data from an authorized user) for an enrollment process of a verification model for the specific user. In an aspect, the workflow 200 may be used to generate both positive and negative exemplars to enable broader continuous learning of various models.

In the illustrated example, portions of the workflow 200 partially or entirely overlap with the workflow 100 of FIG. 1. For example, as discussed above with reference to FIG. 1, in the workflow 200, voice data 105 can be received and processed using a keyword component 110A, before being passed to a quality component 115, keyword component 110B, and verification component 120. The general operations and functionality of the keyword component 110A, quality component 115, keyword component 110B, and verification component 120 in the workflow 200 may generally correspond to, mirror, or otherwise include the operations and functionality discussed above with reference to the workflow 100.

For example, the keyword component 110A may perform an initial detection or search for keywords or phrases in the voice data 105, and selectively provide the voice data 105 to the quality component 115, keyword component 110B, and verification component 120. The quality component 115 can generally be used to evaluate or determine the quality of the voice data 105 (e.g., the duration, SNR, and the like), as discussed above. The keyword component 110B can generally be used to perform more accurate keyword or phrase identification/detection, as discussed above. The verification component 120 can generally be used to verify whether the voice data 105 was uttered or spoken by an authorized user, as discussed above.

In the illustrated workflow 200, the evaluation component 225 evaluates the quality score and keyword score, as discussed above. For example, the evaluation component 225 may confirm that the keyword score meets or exceeds a threshold (e.g., a minimum confidence) to ensure that the voice data 105 is well-suited for training machine learning models. Similarly, the evaluation component 225 can evaluate the quality score(s) or data (e.g., the SNR, duration, and the like) to confirm that the voice data 105 is sufficiently high-quality for accurate training. In an aspect, if any of the criteria are not met, then the evaluation component 225 can discard the voice data 105, as discussed above.

In the illustrated example, the evaluation component 225 does not consider the verification score. That is, the system may determine to use the voice data 105 for training, even if it does not include the voice of an authorized user. For example, in contrast to the workflow 100 of FIG. 1 (which may be used to perform initial enrollment or training of a customized model), the workflow 200 may be used to provide continuous training or refinement of the verification model. In one such aspect, the system may train or refine the model using both positive exemplars (e.g., those where the voice data 105 includes the voice of the authorized user) as well as negative exemplars (e.g., those where the voice data 105 includes the voice of another (unauthorized) user). In some aspects, the negative exemplars may be limited to voice data that is spoken by an unauthorized user, but includes the keyword and is sufficiently-high quality. In some aspects, the negative exemplars can similarly include other data, such as data that does not include the keyword (depending on the particular model being trained or refined).

In at least one aspect, the output of the verification component 120 may be used to label the voice data 105 (e.g., as a positive or negative exemplar), without being used to determine whether to use the voice data 105 for training.

In the illustrated aspect, if the voice data 105 satisfies the criteria, then a labeling component 227 can be used to assign, attach, or otherwise associate a label to the voice data 105. For example, based on the output of the verification component 120, the labeling component 227 may determine whether the voice data 105 is a positive or negative exemplar (e.g., whether it includes the recorded voice of an authorized user, or the recorded voice of an unauthorized or other user), and generate a corresponding label.

In the illustrated example, these labeled exemplars are then stored in the training data 230. This repository may be located locally within the user device, remotely on another user device, and/or remotely on a shared device (such as in the cloud). In some aspects, the training data 230 includes the voice data 105 itself (e.g., the PCM or MFCC data). In some aspects, the training data 230 includes extracted features of the voice data 105. For example, rather than storing the voice data 105, the labeling component 227 (or another component) may process the voice data 105 to extract or generate one or more features of the voice data (e.g., using a feature extraction model).

Generally, the features may have a smaller memory footprint, as compared to the original voice data 105. This can allow them to be stored (e.g., in the training data 230) with a significantly reduced memory or storage footprint. In this way, the system can collect and store a substantial number of training exemplars (e.g., 200 or more) without significant burden.

In an aspect, once the training data 230 satisfies defined criteria, the training component 235 can use it to generate an updated verification model 240. For example, the criteria may include a minimum total number of exemplars, a minimum number of positive exemplars, a minimum number of negative exemplars, and/or a specified ratio of positive-to-negative exemplars (e.g., such that there is a comparable number of positive and negative examples, rather than an overwhelming number of positive examples). In some deployments, positive exemplars may be relatively more common than negative. For example, during ordinary use, if voice data 105 of sufficient quality and containing the keyword(s) or phrase(s) is recorded, then it may be substantially more likely that it was uttered by an authorized user (e.g., the owner of the device) rather than an unauthorized user. In other deployments, the reverse may be true.

In some aspects, therefore, the system (or a remote system) can intelligently inject or provide exemplars as needed to balance the training data 230 and prevent overfitting. For example, if the training data 230 is imbalanced and includes significantly more positive exemplars than negative, then the updated verification model 240 may have reduced accuracy and precision (e.g., failing to reliably identify unauthorized users).

In some aspects, the system (or a remote server, such as the system that initially trained the global verification model) can therefore selectively provide exemplars as needed. For example, if the training data 230 includes a sufficient number of positive exemplars, but insufficient negative exemplars, then the system may inject a number of validated negative exemplars into the training data 230 in order to ensure that the training or refinement results in an accurate model.

When the training criteria are satisfied, in the illustrated workflow 200, the training component 235 can use the stored voice data 105 or extracted features (which is known to include the keyword(s) with sufficiently high confidence and to have sufficiently high quality) to refine, fine-tune, or otherwise train, re-train, or update a user verification machine learning model.

In some aspects, to refine the model, the training component 235 processes the voice data 105 (or extracted features therefrom) to generate an output score (e.g., indicating a probability or confidence that the voice data 105 belongs to the authorized user). This score can then be compared against the known ground-truth (e.g., the label assigned by the labeling component 227), and the difference between the generated score and the ground-truth can be used to refine or update one or more parameters of the model.

In an aspect, the updated verification model 240 may include an updated or refined version of the model currently in use by the verification component 120, an updated architecture, an entirely new model or architecture, and the like. For example, the updated verification model 240 may be the same architecture as the currently-used model, but with refined parameters based on the fine-tuning and/or based on additional global training. Similarly, the updated verification model 240 may have the same architecture, but with updated hyperparameters. As another example, the updated verification model 240 may be an entirely new architecture.

In the illustrated example, the updated verification model 240 can then be deployed/instantiated by the verification component 120 to process new voice data 105. In this way, the system can provide continuous learning and refinement of the verification model, ensuring continued accuracy without downtime or manual re-enrollment, thereby improving the accuracy and efficiency of the system.

Using the workflow 200, during ordinary use, the system can collect, validate, and store voice data 105 (or corresponding features) that is acceptable for training (e.g., for customizing a global model and/or for fine-tuning the customized model) for the specific user or for groups of users. This can allow the system to seamlessly provide updated models without requiring laborious re-enrollment or training.

### Example Workflow for Improved Federated Learning for Machine Learning Models

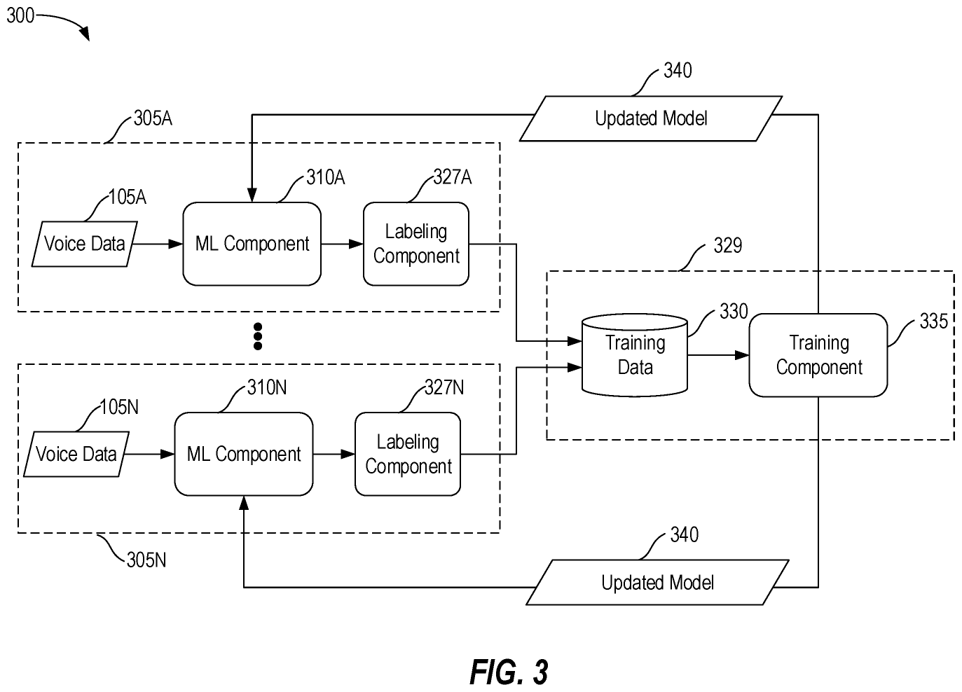

FIG. 3 depicts an example workflow 300 for improved federated learning (referred to in some aspects as surrogated federal learning) for machine learning models. In the illustrated example, the workflow 300 can be used for initial training and/or continuous learning or refinement of models using voice data from a number of devices and/or users. However, as discussed above, aspects of the present disclosure are readily applicable to a wide variety of machine learning tasks.

In some aspects, surrogated federated learning involves offloading some or all of the training process to a separate device or system, whereas conventional federated learning involves each participating system retaining their respective training data locally. For example, in some aspects, user devices may collect and/or label data, and transmit the labeled data (or features) to a remote (trusted) system to train or refine models. In some aspects, user devices can perform training locally (using local data), and transmit the model updates to a centralized system that aggregates the updates from multiple user devices to generate new models.

In some aspects, the workflow 300 shares similarities with the workflow 100 of FIG. 1 and workflow 200 of FIG. 2. As discussed above and in more detail below, the workflow 300 can be used to enable federated learning (e.g., training or re-training of a model on one or more other systems or devices), thereby reducing the computational load on the edge device(s).

In the illustrated example, portions of the workflow 300 partially or entirely overlap with the workflow 100 of FIG. 1 and/or the workflow 200 of FIG. 2. For example, as discussed above with reference to FIGS. 1 and 2, in the workflow 300, voice data 105 can be received and processed to detect or identify keywords, check the quality of the data, verify that the voice data corresponds to an authorized user, and the like (e.g., by the ML components 310A and 310N). In the illustrated example, one portion 305A of the workflow 300 is performed within a first environment (e.g., by a first edge device or user device), while a second portion 305N is performed in another environment (e.g., by a second edge device or user device).

Although two portions 305A and 305N (collectively portions 305) are depicted for conceptual clarity, in aspects, any number of devices or environments may participate in the workflow 300. Additionally, in some aspects, each environment (e.g., each portion 305) may be performed by various devices of a single user. For example, the portion 305A may be performed by a smartphone of the user, while the portion 305N is performed by a smart speaker/digital assistant of the user. In some aspects, some or all of the environments (e.g., each portion 305) may be performed by various devices of different users. For example, the portion 305A may be performed by a device of a first user, while the portion 305N is performed by a device of a second user, where each user is considered to be an authorized user with respect to their environment/device.

In the illustrated example, in the portion 305A, voice data 105A is processed by an ML component 310A. Similarly, in the portion 305N, voice data 105N is processed by an ML component 310N. The operations and functionality ML components 310A and 310N (collectively ML components 310) may generally correspond to, mirror, or otherwise include the operations and functionality of the keyword component 110A, quality component 115, keyword component 110B, verification component 120, and/or evaluation components 125 and 225, as discussed above with reference to FIGS. 1 and 2.

For example, similar to the keyword component 110A of FIGS. 1 and 2, the ML components 310 may perform an initial search for keywords or phrases in the voice data 105, and selectively provide the voice data 105 to downstream components. Similarly, as discussed above with respect to the quality component 115 of FIGS. 1 and 2, the ML components 310 can further be used to evaluate or determine the quality of the voice data 105 (e.g., the duration, SNR, and the like), as discussed above. Additionally, in a similar manner to the keyword component 110B of FIGS. 1 and 2, the ML components 310 can be used to perform more accurate keyword or phrase identification/detection, as discussed above. Similarly to the verification component 120 of FIGS. 1 and 2, the ML components 310 may further be used to verify whether the voice data 105 was uttered or spoken by an authorized user of the environment or device, as discussed above.

In the illustrated workflow 300, similar to the evaluation components 125 and/or 225 of FIGS. 1 and 2, the ML components 310 may also evaluate the quality scores, keyword scores, and/or verification scores, as discussed above. For example, the ML components 310 may confirm that the keyword score meets or exceeds a threshold (e.g., a minimum confidence) to ensure that the voice data 105 is well-suited for training machine learning models. Similarly, the ML components 310 can evaluate the quality score(s) or data (e.g., the SNR, duration, and the like) to confirm that the voice data 105 is sufficiently high-quality for accurate training. In an aspect, if any of the criteria are not met, then the ML components 310 can discard the voice data 105, as discussed above.

In some aspects, as discussed above with reference to FIG. 1, the ML components 310 can further evaluate the verification score to ensure that it meets defined criteria (e.g., if the workflow 300 is being used to perform enrollment for a single user). In some aspects, as discussed above with reference to FIG. 2, the ML components 310 may not evaluate the verification score (e.g., if the workflow 300 is being used to provide continuous learning, or if the system otherwise needs or desires both positive and negative exemplars).

In the illustrated aspect, if the ML components 310 determines that the corresponding voice data 105 satisfies defined criteria, as discussed above, then a labeling component 327A or 327N (collectively labeling components 327) can be used to assign, attach, or otherwise associate a label to the voice data 105. Specifically, the labeling component 327A can be used to label data in the portion 305A, and the labeling component 327N can be used to label data in the portion 305N.

In some aspects, the particular label(s) assigned may differ depending on the underlying training goal. For example, based on the output of the user verification portion of the ML components 310, the labeling components 327 may determine whether the voice data 105 is a positive or negative exemplar (e.g., whether it includes the recorded voice of an authorized user, or the recorded voice of an unauthorized or other user), and generate a corresponding label. As another example, based on the output of the keyword identification portion of the ML components 310, the labeling components 327 may determine whether the voice data 105 is a positive or negative exemplar (e.g., whether it includes a defined keyword or phrase), and generate a corresponding label.

In the illustrated example, these labeled exemplars are then transmitted to another device or system, as represented by the portion 329. Specifically, the training exemplars from each discrete portion 305 are transmitted and stored in a shared training data 330. This repository may be located on another user device (e.g., a device that also participates in the federated learning and performs data collection and labeling), on a user device that does not participate (e.g., a desktop computer or server managed by the user), and/or on a remote system (such as in the cloud).

In some aspects, the training data 330 includes the voice data 105 itself (e.g., the PCM or MFCC data). That is, each user device may transmit the original voice data 105. In some aspects, each user device (e.g., the labeling components 327) may instead perform feature extraction, allowing the training data 330 to include extracted features of the voice data 105. As discussed above, the features may generally have a smaller memory footprint, as compared to the original voice data 105. This can allow them to be transmitted and stored (e.g., in the training data 330) with a significantly reduced memory or storage footprint. In this way, the system can reduce the bandwidth and network burden of the workflow 300, while also collecting and storing a substantial number of training exemplars (e.g., 200 or more) without significant burden.

In an aspect, once the training data 330 satisfies defined criteria, the training component 335 can use it to generate an updated model 340. For example, as discussed above, the criteria may include a minimum total number of exemplars (e.g., in the case of enrolling a user for a new model), a minimum number of positive exemplars, a minimum number of negative exemplars, and/or a specified ratio of positive-to-negative exemplars (e.g., such that there is a comparable number of positive and negative examples, rather than an overwhelming number of positive or negative examples).

In some deployments, positive exemplars may be relatively more common than negative. For example, during ordinary use, if voice data 105 of sufficient quality and containing the keyword(s) or phrase(s) is recorded, then it may be substantially more likely that it was uttered by an authorized user (e.g., the owner of the device) rather than an unauthorized user. In other deployments, the reverse may be true. Similarly, during ordinary use, if voice data 105 of sufficient quality is collected, then it may be substantially more likely that it contains the defined keyword(s) or phrase(s), rather than not including the keyword.

In some aspects, therefore, the system (or a remote system) can intelligently inject or provide exemplars as needed to balance the training data 330 and prevent overfitting. For example, if the training data 330 is imbalanced and includes significantly more positive exemplars than negative, then the updated model 340 may have reduced accuracy and precision (e.g., failing to reliably identify unauthorized users).

In some aspects, the system corresponding to the portion 329 can therefore selectively provide exemplars as needed. For example, if the training data 330 includes a sufficient number of positive exemplars, but insufficient negative exemplars, then the system may inject a number of validated negative exemplars into the training data 330 in order to ensure that the training or refinement results in an accurate model.

When the training criteria are satisfied, in the illustrated workflow 300, the training component 335 can use the stored voice data 105 or extracted features (which are each known to be sufficiently high quality, as well as a corresponding label) to refine, fine-tune, or otherwise train, re-train, or update a one or more machine learning models (e.g., user verification models, keyword detection models, and the like).

In some aspects, to refine the model, the training component 335 processes the voice data 105 (or extracted features therefrom) to generate an output score (e.g., indicating a probability or confidence that the voice data 105 belongs to the authorized user, and/or indicating a probability or confidence that the voice data 105 includes utterance of a defined keyword or phrase). This score can then be compared against the known ground-truth (e.g., the label assigned by the labeling components 327), and the difference between the generated score and the ground-truth can be used to refine or update one or more parameters of the model.

In an aspect, the updated model 340 may include an updated or refined version of the model currently in use by the ML components 310, an updated architecture, an entirely new model or architecture, and the like. For example, the updated model 340 may be the same architecture as the currently-used model, but with refined parameters based on the fine-tuning and/or based on additional global training. Similarly, the updated model 340 may have the same architecture, but with new parameters generated using updated hyperparameters. As another example, the updated model 340 may be an entirely new architecture.

In the illustrated example, the updated model 340 can then be deployed/instantiated to each ML component 310 that participates in the federated learning workflow 300 to process new voice data 105. In this way, the system can provide continuous learning and refinement of the models (e.g., the keyword detection models and/or user verification models), ensuring continued accuracy without downtime or manual re-enrollment, thereby improving the accuracy and efficiency of the system.

Using the workflow 300, during ordinary use, the system can collect, validate, and store voice data 105 (or corresponding features) that are acceptable for training (e.g., for customizing a global model and/or for fine-tuning the customized model) using a federated learning environment (e.g., a collection of edge devices and one or more centralized systems). This can allow the system to seamlessly provide updated models without requiring laborious re-enrollment or training.

### Example Method for Seamless Updating of Machine Learning Models

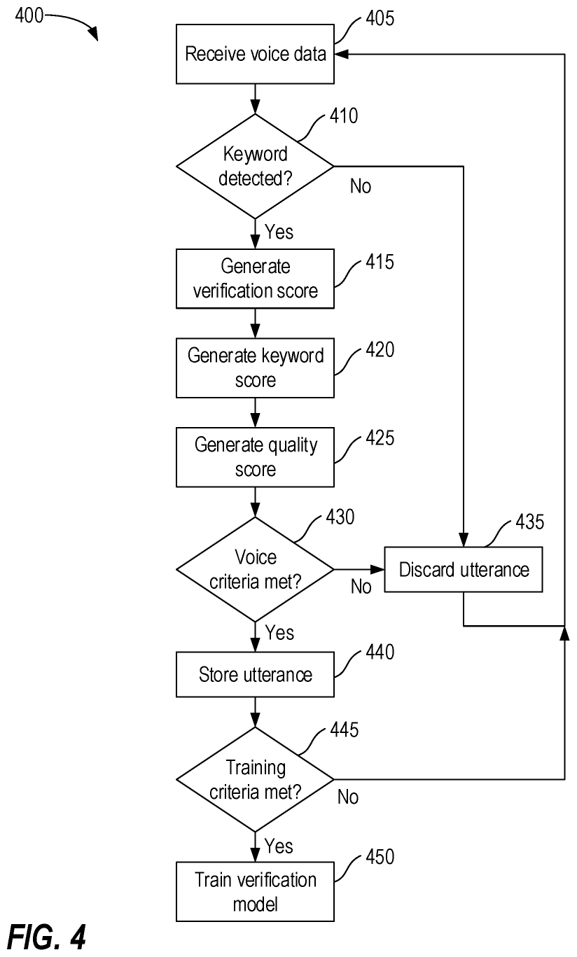

FIG. 4 is a flow diagram depicting an example method 400 for seamless updating of machine learning models. In the illustrated example, the method 400 can be used for training or enrollment for user verification using voice data. However, as discussed above, aspects of the present disclosure are readily applicable to a wide variety of machine learning tasks. In some aspects, the method 400 is performed by an edge device (also referred to as an end device or user device), such as a smartphone, a smart watch, a laptop, a smart speaker or digital assistant, and the like. In at least one aspect, the method 400 provides additional detail for the workflow 100 of FIG. 1.

At block 405, the user device receives voice data (e.g., voice data 105 of FIGS. 1-3). As discussed above, the voice data can generally correspond to recorded audio (e.g., by one or more microphones of the user device). For example, the voice data may correspond to PCM data, MFCC data, and the like. As discussed above, though referred to as voice data for conceptual clarity, the voice data may or may not actually contain a voice. That is, the voice data may include a recording of a user's voice, or may be background noise or other data.

At block 410, the user device evaluates the voice data to determine whether it contains one or more defined keywords or phrases. For example, the user device may use a lightweight initial machine learning model (e.g., keyword component 110A of FIGS. 1 and 2) to determine whether the voice data includes (or likely includes) a keyword or phrase. In some aspects, the keyword or phrase may be from a predefined (static) list, or may be a user-specific customized word or phrase. As discussed above, this initial detection may be performed using a relatively lightweight model that requires fewer resources (e.g., smaller memory footprint, reduced processor time, reduced latency, and the like), as compared to downstream keyword detection.

If, at block 410, the user device determines that no keyword was detected in the voice data, the method 400 continues to block 435, where the user device discards the utterance (e.g., the voice data). The method 400 then returns to block 405. In this way, the user device can selectively process the voice data using downstream models (which are often more complex and computationally expensive), thereby reducing the computational resources needed to process the voice data, and improving the operations of the user device. In an aspect, discarding the utterance/voice data can generally include refraining from storing or further processing it, deleting it from storage or memory, and the like.

If, at block 410, the user device determines that a keyword or phrase is present in the voice data, the method 400 continues to block 415. At block 415, the user device generates a verification score for the voice data by processing the data using a trained machine learning model. For example, using verification component 120 of FIGS. 1 and 2, the user device may process the data to determine whether the voice data includes the voice of an authorized user of the user device. That is, the user device may determine whether the uttered keyword was spoken by the authorized user, using a trained/customized user verification voice model. In some aspects, the verification score is a continuous value indicating a probability or confidence that the voice belongs to the user. In some aspects, the verification score is a binary classification.

At block 420, the user device generates a keyword score by processing the voice data using a trained machine learning model. For example, using keyword component 110B of FIGS. 1 and 2, the user device may process the voice data to determine whether a keyword or phrase was uttered in the voice data. As discussed above, this second stage of keyword recognition may use relatively more robust models (typically requiring more computational resources, as compared to the initial stage), and often provide improved accuracy (e.g., fewer false positives). In some aspects, the keyword score is a continuous value indicating a probability or confidence that the voice data includes utterance of a keyword or phrase. In some aspects, the keyword score is a binary value.

At block 425, the user device generates a quality score for the voice data. For example, using quality component 115 of FIGS. 1 and 2, the user device may generate an overall quality score and/or a composite score including sub-elements based on the quality of the voice data. As one example, the user device may determine whether the audio satisfies a minimum duration requirement, whether the clipping is below a threshold, whether the SNR is above a threshold, whether the keyword ratio exceeds a threshold, and the like. In some aspects, the quality score is a binary classification indicating whether the voice data is sufficiently-high quality (e.g., whether the components of quality used by the user device meet or exceed the required criteria). In some aspects, the quality score is a continuous value indicating the quality of the data (where higher values correspond to higher quality), and/or indicating the probability or confidence that the voice data is sufficiently high quality.

Although depicted as sequential operations for conceptual clarity, in some aspects, blocks 415, 420, and 425 may be performed substantially in parallel to reduce latency of the method 400. In other aspects, the operations may be performed sequentially and/or conditionally (in any order) to reduce computational expense. For example, the user device may first determine whether the verification score meets a threshold, before proceeding to generate the keyword score or quality score.

Once the verification score, keyword score, and quality score have been generated, the method 400 continues to block 430. At block 430, the user device determines whether specified voice criteria are satisfied. In some aspects, the voice criteria can include a determination as to whether the user device is even in the process of enrolling or fine-tuning a new verification model. In some aspects, as discussed above, the voice criteria can include minimum threshold values for the verification score, keyword score, and/or quality score. That is, the user device can determine whether the voice data is sufficiently high quality, includes utterance of a keyword or phrase (with sufficiently high probability or confidence), and/or that the utterance is in the voice of an authorized user (with sufficiently high probability or confidence).

If the voice criteria are not satisfied (e.g., if any of the scores do not meet the criteria), the method 400 continues to block 435, where the user device discards the utterance/voice data. The method 400 then returns to block 405. In this way, the user device can selectively store the voice data for future training (which may depend on high-quality and accurate data), thereby improving the model accuracy, simplifying or easing the training process, and improving the operations of the user device. In an aspect, discarding the utterance/voice data can generally include refraining from storing or further processing it, deleting it from storage or memory, and the like.

If, at block 430, the user device determines that the voice criteria are satisfied, then the method 400 continues to block 440 where the user device stores the utterance/voice data. In some aspects, as discussed above, storing the utterance can include storing the original voice data (e.g., PCM or MFCC data), or extracting and storing features from the voice data. In some aspects, the voice data is stored in a secure repository (e.g., one only accessible to specified operations or processes of the user device, rather than to all applications).

At block 445, the user device determines whether training criteria are met. In some aspects, the training criteria can include a minimum number of exemplar utterances stored during block 440 (e.g., a minimum of five exemplars). In some aspects, the training criteria can include considerations related to the workload of the user device, such as whether any computationally expensive processes are ongoing, whether the user is currently using the user device, whether sufficient memory or processing capacity is available to train, and the like. In at least one aspect, the training criteria include a time of day and/or day of the week (e.g., where the training is deferred to specific windows of time, such as overnight).

If the training criteria is not satisfied, the method 400 returns to block 405. In this way, the user device can continue to collect, validate, and store or discard voice data during normal operations of the user device (e.g., as the user uses the device normally, including using the keyword detection and/or user verification functionality).

If the user device determines that the training criteria is met, the method 400 continues to block 450, where the user device trains, refines, or fine-tunes a user verification model. For example, as discussed above, the user device may use the stored utterances to perform enrollment, fine-tuning, and/or customization of a global verification model for the specific user. In this way, the method 400 allows new models and architectures to be dynamically deployed to user devices without interfering with the normal operations or requiring any manual effort by the user. Although not included in the illustrated example, in some aspects, the customized verification model can then be deployed by the user device (e.g., to be used to verify the user's identity for future voice data).

Although not included in the illustrated example, in some aspects, after the training completes, the user device can discard or delete the voice data (or extracted features). This can reduce the memory/storage requirements of the method 400, and preserve user privacy. In at least one aspect, rather than deleting the voice data, the user device can transfer it to a secure enclave, repository, or portion of a repository where the voice data can be maintained in a highly secure manner. For example, the secure repository may be protected using encryption of its contents (which may allow it to be stored in any location), may be accessible only to specified operations or processes on the user device (e.g., to the kernel), may be inaccessible to third-party applications (or even the operating system of the user device), may be stored in different storage entirely (e.g., with a hardware boundary between the secure storage and the remaining memory or storage used by the device), and the like. This can allow the user device to selectively retain the utterances for future use, in some aspects, without compromising user privacy.

### Example Method for Continuous Learning for Machine Learning Models

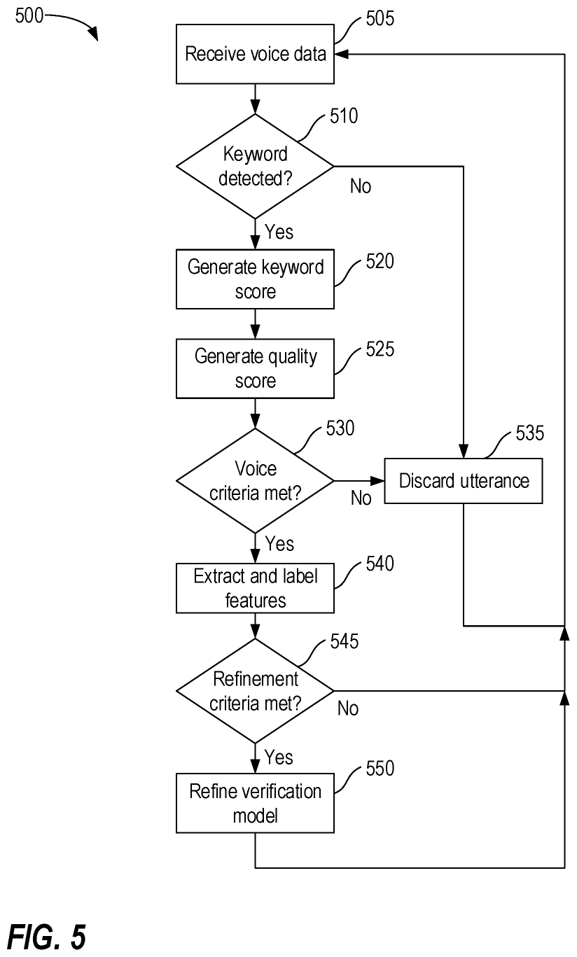

FIG. 5 is a flow diagram depicting an example method 500 for continuous learning for machine learning models. In the illustrated example, the method 500 can be used for continuous learning or refinement of user verification models using voice data. However, as discussed above, aspects of the present disclosure are readily applicable to a wide variety of machine learning tasks. In some aspects, the method 500 is performed by an edge device. In at least one aspect, the method 500 provides additional detail for the workflow 200 of FIG. 2.

In some aspects, the method 500 shares similarities with the method 400 of FIG. 4. For example, blocks 505, 510, 520, 525, 530, and 535 may include similar operations or processes as blocks 405, 410, 420, 425, 430, and 435, respectively.

At block 505, the user device receives voice data (e.g., voice data 105 of FIGS. 1-3). As discussed above (e.g., with reference to block 405 of FIG. 4, and/or with reference to FIGS. 1-3), the voice data can generally correspond to recorded audio (e.g., by one or more microphones of the user device).

At block 510, the user device evaluates the voice data to determine whether it contains one or more defined keywords or phrases. For example, as discussed above with reference to block 410 of FIG. 4, the user device may use a lightweight initial machine learning model (e.g., keyword component 110A of FIGS. 1 and 2) to determine whether the voice data includes (or likely includes) a keyword or phrase.

If, at block 510, the user device determines that no keyword was detected in the voice data, then the method 500 continues to block 535, where the user device discards the utterance (e.g., the voice data). The method 500 then returns to block 505.

If, at block 510, the user device determines that a keyword or phrase is present in the voice data, then the method 500 continues to block 520. At block 520, the user device generates a keyword score by processing the voice data using a trained machine learning model. For example, as discussed above with reference to block 420 of FIG. 4, using keyword component 110B of FIGS. 1 and 2, the user device may process the voice data to determine whether a keyword or phrase was uttered in the voice data.

At block 525, the user device generates a quality score for the voice data. For example, as discussed above with reference to block 425 of FIG. 4, using quality component 115 of FIGS. 1 and 2, the user device may generate an overall quality score and/or a composite score including sub-elements based on the quality of the voice data.

Although depicted as sequential operations for conceptual clarity, in some aspects, blocks 520 and 525 may be performed substantially in parallel to reduce latency of the method 500. In other aspects, the operations may be performed sequentially and/or conditionally (in any order) to reduce computational expense. For example, the user device may first determine whether the keyword score meets a threshold, before proceeding to generate the quality score.

Once the keyword score and quality score have been generated, the method 500 continues to block 530. At block 530, the user device determines whether specified voice criteria are satisfied. In some aspects, as discussed above, the voice criteria can include minimum threshold values for the keyword score and/or quality score. That is, the user device can determine whether the voice data is sufficiently high quality, and/or includes utterance of a keyword or phrase (with sufficiently high probability or confidence).

If the voice criteria are not satisfied (e.g., if any of the scores do not meet the criteria), the method 500 continues to block 535, where the user device discards the utterance/voice data. The method 500 then returns to block 505.

If, at block 530, the user device determines that the voice criteria are satisfied, then the method 500 continues to block 540, where the user device can extract features from the voice data, and/or label the voice data (or extracted features). In some aspects, as discussed above, the user device labels the data based on whether the recorded voice corresponds to an authorized user (e.g., as determined using a user verification model). In some aspects, the user device extracts and labels features, and stores these features for subsequent training. In other aspects, the user device can label the voice data directly, and store it for subsequent training, as discussed above.

At block 545, the user device determines whether refinement criteria are met. In some aspects, the refinement criteria can include a minimum number of exemplar utterances labeled/stored during block 540, a minimum number of positive exemplars, a minimum number of negative exemplars, a specific ratio (or range of ratios) of positive-to-negative exemplars, and the like. In some aspects, the refinement criteria can include considerations related to the workload of the user device, whether the user is currently using the user device, whether sufficient memory or processing capacity is available to train, and the like. In at least one aspect, the refinement criteria include a time of day and/or day of the week.

If the refinement criteria is not satisfied, the method 500 returns to block 505. In this way, the user device can continue to collect, validate, and store or discard voice data during normal operations of the user device (e.g., as the user uses the device normally, including using the keyword detection and/or user verification functionality).

If the user device determines that the refinement criteria is met, then the method 500 continues to block 550, where the user device trains, refines, or fine-tunes a user verification model. For example, as discussed above, the user device may use the stored utterances (or features) to perform continuous online updating or learning of a user verification model for the specific user. In this way, the method 500 allows the verification models to be continuously updated and refined without interfering with the normal operations or requiring any manual effort by the user. Although not included in the illustrated example, in some aspects, the updated verification model can then be deployed by the user device (e.g., to be used to verify the user's identity for future voice data).

Although not included in the illustrated example, in some aspects, after the refinement completes, the user device can discard or delete the voice data (or extracted features). This can reduce the memory/storage requirements of the method 500, and preserve user privacy. In at least one aspect, rather than deleting the voice data, the user device can transfer it to a secure enclave, repository, or portion of a repository where the voice data can be maintained in a secure manner.

Additionally, in at least one aspect, the user device can store the voice data and/or features securely, and automatically delete them upon occurrence of defined criteria (such as an age of the data, a number of exemplars being stored, and the like). For example, the user device may delete any exemplars that are older than six months, delete the oldest exemplars when the total number of exemplars stored meets or exceeds a threshold, and the like.

### Example Method for Improved Federated Learning for Machine Learning Models

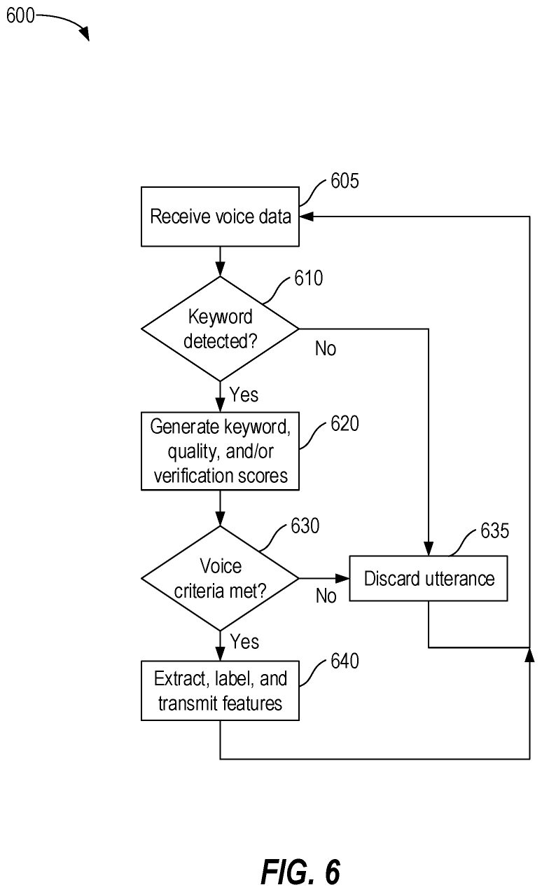

FIG. 6 is a flow diagram depicting an example method 600 for improved federated learning for machine learning models. In the illustrated example, the method 600 can be used for initial training and/or continuous learning or refinement of models using voice data from a number of devices and/or users. However, as discussed above, aspects of the present disclosure are readily applicable to a wide variety of machine learning tasks. In some aspects, the method 500 is performed by an edge device. In at least one aspect, the method 600 provides additional detail for the workflow 300 of FIG. 3.

In some aspects, the method 600 shares similarities with the method 400 of FIG. 4 and/or method 500 of FIG. 5. For example, blocks 605, 610, 630, and 635 may include similar operations or processes as blocks 405, 410, 430, and 435, respectively. Similarly, block 620 may include similar operations to blocks 415, 420, and/or 425 of FIG. 4.

At block 605, the user device receives voice data (e.g., voice data 105 of FIGS. 1-3). As discussed above (e.g., with reference to block 405 of FIG. 4, block 505 of FIG. 5, and/or with reference to FIGS. 1-3), the voice data can generally correspond to recorded audio (e.g., by one or more microphones of the user device).

At block 610, the user device evaluates the voice data to determine whether it contains one or more defined keywords or phrases. For example, as discussed above with reference to block 410 of FIG. 4, the user device may use a lightweight initial machine learning model (e.g., keyword component 110A of FIGS. 1 and 2, and/or ML component 310 of FIG. 3) to determine whether the voice data includes (or likely includes) a keyword or phrase.

If, at block 610, the user device determines that no keyword was detected in the voice data, the method 600 continues to block 635, where the user device discards the utterance (e.g., the voice data). The method 600 then returns to block 605.

If, at block 610, the user device determines that a keyword or phrase is present in the voice data, the method 600 continues to block 615. At block 620, the user device generates a verification score, a keyword score, and/or a quality score for the voice data. In some aspects, as discussed above, the user device generates the verification score by processing the data using a trained machine learning model (e.g., verification component 120 of FIGS. 1 and 2, and/or ML component 310 of FIG. 3), in order to determine whether the voice data includes the voice of an authorized user of the user device.

In some aspects, as discussed above, the keyword score is generated by processing the voice data using a trained machine learning model (e.g., keyword component 110B of FIGS. 1 and 2, and/or ML component 310 of FIG. 3) to determine whether a keyword or phrase was uttered in the voice data. As discussed above, this second stage of keyword recognition may use relatively more robust models (typically requiring more computational resources, as compared to the initial stage), and often provide improved accuracy (e.g., fewer false positives).

In some aspects, as discussed above, the user device generates the quality score (e.g., using quality component 115 of FIGS. 1 and 2, and/or ML component 310 of FIG. 3) to generate an overall quality score and/or a composite score including sub-elements based on the quality of the voice data.

Once the verification score, keyword score, and/or quality score have been generated, the method 600 continues to block 630. At block 630, the user device determines whether specified voice criteria are satisfied. In some aspects, as discussed above, the voice criteria can include minimum threshold values for the verification score, keyword score, and/or quality score. That is, the user device can determine whether the voice data is sufficiently high quality, includes utterance of a keyword or phrase (with sufficiently high probability or confidence), and/or that the utterance is in the voice of an authorized user (with sufficiently high probability or confidence).

If the voice criteria are not satisfied (e.g., if any of the scores do not meet the criteria), the method 600 continues to block 635, where the user device discards the utterance/voice data. The method 600 then returns to block 605.

If, at block 630, the user device determines that the voice criteria are satisfied, then the method 600 continues to block 640 where the user device can extract features from the voice data, and/or label the voice data (or extracted features). In some aspects, as discussed above, the user device labels the data based on whether the recorded voice corresponds to an authorized user (e.g., as determined using a user verification model). In some aspects, the user device labels the data based on whether the voice data includes a defined keyword or phrase (e.g., as determined using a keyword model). In the illustrated example, the user device can then transmit the labeled data (or features) to another system, such as in a federated learning system.

As discussed above with reference to FIG. 3, the other system to which the features are transmitted can similarly receive labeled features from any number of user devices. Using this aggregate set of data, the system can train or refine a variety of machine learning models (e.g., using a federated learning architecture). In the illustrated example, after transmitting the labeled features, the method 600 returns to block 605. In this way, the method 600 allows the user device to continuously collect training data for training and/or refining models without interfering with the normal operations or requiring any manual effort by the user. Although not included in the illustrated example, in some aspects, the updated model(s) can then be deployed, by the remote training system, to the user device(s) (e.g., to be used to verify the user's identity for future voice data, or to perform future keyword detection).

Although not included in the illustrated example, in some aspects, after the features are transmitted, the user device can discard or delete the voice data (or extracted features). This can reduce the memory/storage requirements of the method 600, and preserve user privacy. In at least one aspect, rather than deleting the voice data, the user device can transfer it to a secure enclave, repository, or portion of a repository where the voice data can be maintained in a highly secure manner.

Additionally, in at least one aspect, the user device can store the voice data and/or features securely, and automatically delete them upon occurrence of defined criteria (such as an age of the data, a number of exemplars being stored, and the like). For example, the user device may delete any exemplars that are older than six months, delete the oldest exemplars when the total number of exemplars stored meets or exceeds a threshold, and the like.

### Example Method for Updating User Verification Models

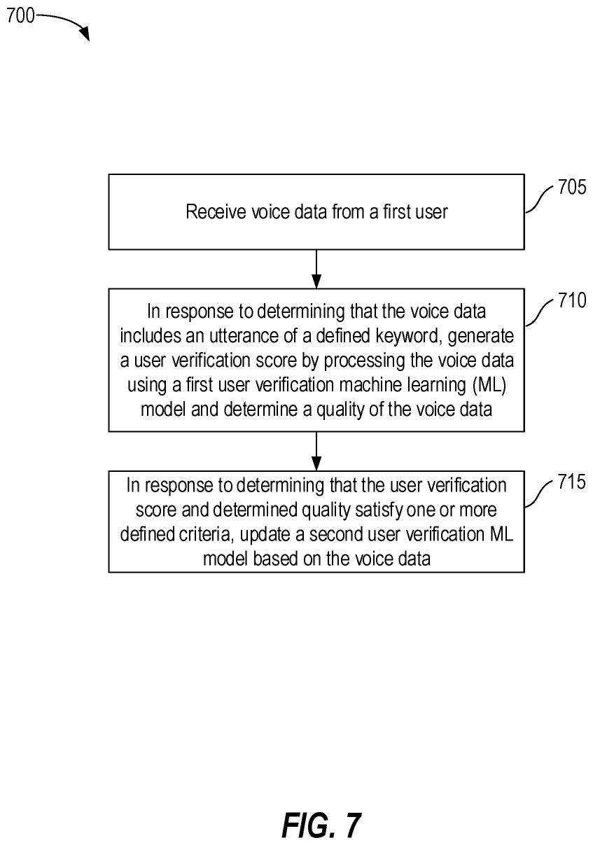

FIG. 7 is a flow diagram depicting an example method 700 for updating user verification models. In some aspects, the method 700 is performed by an edge device (also referred to as an end device or user device), as discussed above.

At block 705, voice data from a first user is received.

At block 710, in response to determining that the voice data includes an utterance of a defined keyword, a user verification score is generated by processing the voice data using a first user verification machine learning (ML) model, and a quality of the voice data is determined.

At block 715, in response to determining that the user verification score and determined quality satisfy one or more defined criteria, a second user verification ML model is updated based on the voice data.

In some aspects, determining that the voice data includes the utterance of the defined keyword comprises processing the voice data using a first keyword identification ML model, the method 700 further comprises confirming that the voice data includes the utterance of the defined keyword by processing the voice data using a second keyword identification ML model, and the second keyword identification ML model is more accurate than the first keyword identification ML model.

In some aspects, determining the quality of the voice data comprises at least one of: determining a signal-to-noise (SNR) ratio of the voice data, determining a clipping ratio of the voice data, or determining a duration of the voice data.

In some aspects, the method 700 further includes storing the voice data as a training exemplar, wherein updating the second user verification ML model is performed based further in response to determining that a number of stored training exemplars satisfies one or more defined criteria.

In some aspects, the method 700 further includes, subsequent to updating the second user verification ML model, deleting the stored training exemplars.

In some aspects, the method 700 further includes, subsequent to updating the second user verification ML model, storing the training exemplars in a storage location that satisfies one or more defined security criteria.

In some aspects, the method 700 further includes using the second user verification ML model to process subsequent voice data.

In some aspects, updating a second user verification ML model based on the voice data comprises extracting one or more features of the voice data, labeling the one or more features of the voice data based on the user verification score, and storing the one or more features and the label as a training exemplar.

In some aspects, updating the second user verification ML model based on the voice data is performed based further in response to determining that a number of stored training exemplars satisfies one or more defined criteria, wherein the one or more defined criteria indicates at least one of: a minimum number of stored positive exemplars corresponding to utterances made by a first user, a minimum number of stored negative exemplars corresponding to utterances not made by the first user, or a ratio of stored positive exemplars to stored negative exemplars.

In some aspects, updating the second user verification ML model is performed using a federated learning operation.

In some aspects, the federated learning operation comprises transmitting the training exemplar to a host system that performs the updating of the second user verification ML model.

In some aspects, the federated learning operation comprises transmitting updated parameters of the second user verification ML model to a host system, wherein the host system aggregates updated parameters to update a global version of the second user verification ML model.

### Example Method for Evaluating Voice Data for Improved Machine Learning

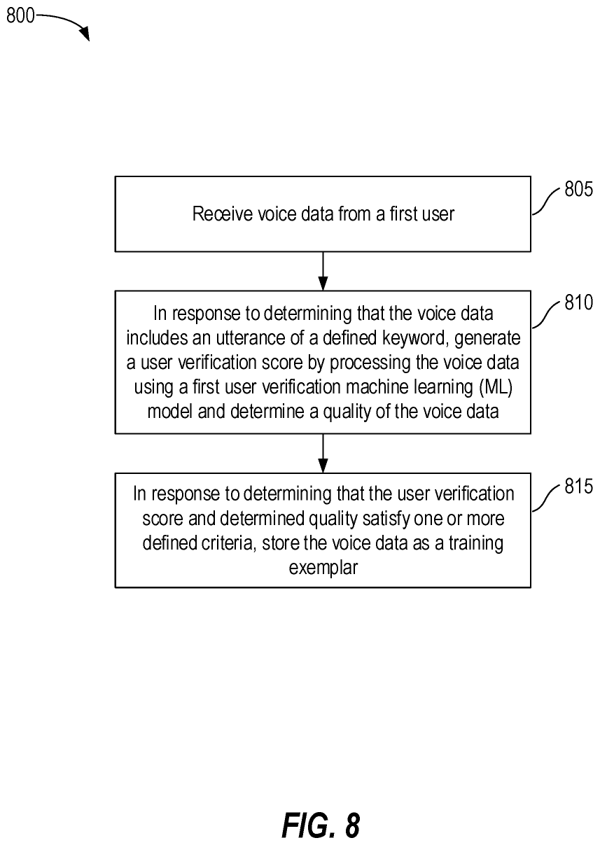

FIG. 8 is a flow diagram depicting an example method 800 for evaluating voice data for improved machine learning. In some aspects, the method 800 is performed by an edge device (also referred to as an end device or user device), as discussed above.

At block 805, voice data from a first user is received.

At block 810, in response to determining that the voice data includes an utterance of a defined keyword, a user verification score is generated by processing the voice data using a first user verification machine learning (ML) model and a quality of the voice data is determined.

At block 815, in response to determining that the user verification score and determined quality satisfy one or more defined criteria, the voice data is stored as a training exemplar.

In some aspects, determining that the voice data includes the utterance of the defined keyword comprises processing the voice data using a first keyword identification ML model, the method 800 further comprises confirming that the voice data includes the utterance of the defined keyword by processing the voice data using a second keyword identification ML model, and the second keyword identification ML model is more accurate than the first keyword identification ML model.

In some aspects, the method 800 further includes updating a second user verification ML model based further in response to determining that a number of stored training exemplars satisfies one or more defined criteria.

In some aspects, the method 800 further includes, subsequent to updating the second user verification ML model, deleting the stored training exemplars.

In some aspects, the method 800 further includes, subsequent to updating the second user verification ML model, storing the training exemplars in a storage location that satisfies one or more defined security criteria.

In some aspects, the method 800 further includes using the second user verification ML model to process subsequent voice data.

### Example Processing System

In some aspects, the workflows, techniques, and methods described with reference to FIGS. 1-8 may be implemented on one or more devices or systems. FIG. 9 depicts an example processing system 900 configured to perform various aspects of the present disclosure, including, for example, the techniques and methods described with respect to FIGS. 1-8. In one aspect, the processing system 900 may correspond to an edge device, such as a smartphone, a smart watch, a laptop, a smart speaker or digital assistant, and the like. In some aspects, the processing system 900 includes a training system (e.g., for federated learning). Although depicted as a single system for conceptual clarity, in at least some aspects, as discussed above, the operations described below with respect to the processing system 900 may be distributed across any number of devices. For example, a first system may train the model(s) while a second system uses the trained models to evaluate voice data.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., in memory 924).

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a keyword component 924A, a verification component 924B, a quality component 924C, a feature component 924D, and a training component 924E. The memory 924 also includes a set of training exemplars 924F and model parameters 924G. Though depicted as discrete components for conceptual clarity in FIG. 9, the illustrated components (and others not depicted) may be collectively or individually implemented in various aspects.

The training exemplars 924F may generally correspond to stored voice data and/or features, as discussed above. For example, the training exemplars 924F may include PCM/MFCC data and/or extracted features (e.g., from voice data 105 of FIGS. 1-3), along with corresponding labels as appropriate (e.g., indicating whether the exemplar includes a keyword, whether it was uttered by an authorized user, and the like). The model parameters 924G may generally correspond to the parameters of all or a part of one or more machine learning models, such as one or more keyword detection models, user verification models, and the like.

Processing system 900 further comprises keyword circuit 926, verification circuit 927, quality circuit 928, feature circuit 929, and training circuit 930. The depicted circuits, and others not depicted, may be configured to perform various aspects of the techniques described herein.

For example, keyword component 924A and keyword circuit 926 (which may correspond to the keyword components 110A and/or 110B of FIGS. 1-2) may be used to process voice data to detect the presence of keyword(s) or phrase(s), as discussed above. Verification component 924B and verification circuit 927 (which may correspond to the verification component 120 of FIGS. 1-2) may be used to process voice data to determine whether the speaker(s), if any, are authorized users, as discussed above. Quality component 924C and quality circuit 928 (which may correspond to the quality component 115 of FIGS. 1-2) may be used to evaluate and quantify the audio quality of the recorded voice data, as discussed above. Feature component 924D and feature circuit 929 (which may correspond to the labeling component 227 of FIG. 2 and/or labeling component 327 of FIG. 3) may be used to extract features from voice data, label the features, and the like. Training component 924E and training circuit 930 (which may correspond to the training component 135 of FIG. 1, training component 235 of FIG. 2, and/or training component 335 of FIG. 3) may be used to compute losses and/or to refine the machine learning models (e.g., user verification models), as discussed above.

Though depicted as separate components and circuits for clarity in FIG. 9, keyword circuit 926, verification circuit 927, quality circuit 928, feature circuit 929, and training circuit 930 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia processing unit 910, wireless connectivity component 912, sensor processing units 916, ISPs 918, and/or navigation processor 920 may be omitted in other aspects. Further, aspects of processing system 900 maybe distributed between multiple devices.

### Example Clauses

Implementation examples are described in the following numbered clauses:

Clause 1: A method for training a machine learning model for user verification, comprising: receiving voice data from a first user; in response to determining that the voice data includes an utterance of a defined keyword: generating a user verification score by processing the voice data using a first user verification machine learning (ML) model; and determining a quality of the voice data; and in response to determining that the user verification score and determined quality satisfy one or more defined criteria, updating a second user verification ML model based on the voice data.

Clause 2: A method according to Clause 1, wherein: determining that the voice data includes the utterance of the defined keyword comprises processing the voice data using a first keyword identification ML model, the method further comprises confirming that the voice data includes the utterance of the defined keyword by processing the voice data using a second keyword identification ML model, and the second keyword identification ML model is more accurate than the first keyword identification ML model.

Clause 3: A method according to any one of Clauses 1-2, wherein determining the quality of the voice data comprises at least one of: determining a signal-to-noise (SNR) ratio of the voice data; determining a clipping ratio of the voice data; or determining a duration of the voice data.

Clause 4: A method according to any one of Clauses 1-3, further comprising storing the voice data as a training exemplar, wherein updating the second user verification ML model is performed based further in response to determining that a number of stored training exemplars satisfies one or more defined criteria.

Clause 5: A method according to any one of Clauses 1-4, further comprising, subsequent to updating the second user verification ML model, deleting the stored training exemplars.

Clause 6: A method according to any one of Clauses 1-5, further comprising, subsequent to updating the second user verification ML model, storing the training exemplars in a storage location that satisfies one or more defined security criteria.

Clause 7: A method according to any one of Clauses 1-6, further comprising using the second user verification ML model to process subsequent voice data.

Clause 8: A method according to any one of Clauses 1-7, wherein updating the second user verification ML model based on the voice data comprises: extracting one or more features of the voice data; labeling the one or more features of the voice data based on the user verification score; and storing the one or more features and the label as a training exemplar.

Clause 9: A method according to any one of Clauses 1-8, wherein updating the second user verification ML model based on the voice data is performed based further in response to determining that a number of stored training exemplars satisfies one or more defined criteria, wherein the one or more defined criteria indicates at least one of: a minimum number of stored positive exemplars corresponding to utterances made by a first user; a minimum number of stored negative exemplars corresponding to utterances not made by the first user; or a ratio of stored positive exemplars to stored negative exemplars.

Clause 10: A method according to any one of Clauses 1-9, wherein updating the second user verification ML model is performed using a federated learning operation.

Clause 11: A method according to any one of Clauses 1-10, wherein the federated learning operation comprises transmitting the training exemplar to a host system that performs the updating of the second user verification ML model.

Clause 12: A method according to any one of Clauses 1-11, wherein the federated learning operation comprises transmitting updated parameters of the second user verification ML model to a host system, wherein the host system aggregates updated parameters to update a global version of the second user verification ML model.

Clause 13: A method for performing user verification using machine learning, comprising: receiving voice data from a first user; in response to determining that the voice data includes an utterance of a defined keyword: generating a user verification score by processing the voice data using a first user verification machine learning (ML) model; and determining a quality of the voice data; and in response to determining that the user verification score and determined quality satisfy one or more defined criteria, storing the voice data as a training exemplar.

Clause 14: A method according to Clause 13, wherein: determining that the voice data includes the utterance of the defined keyword comprises processing the voice data using a first keyword identification ML model, the method further comprises confirming that the voice data includes the utterance of the defined keyword by processing the voice data using a second keyword identification ML model, and the second keyword identification ML model is more accurate than the first keyword identification ML model.

Clause 15: A method according to any one of Clauses 13-14, further comprising updating a second user verification ML model based further in response to determining that a number of stored training exemplars satisfies one or more defined criteria.

Clause 16: A method according to any one of Clauses 13-15, further comprising, subsequent to updating the second user verification ML model, deleting the stored training exemplars.

Clause 17: A method according to any one of Clauses 13-16, further comprising, subsequent to updating the second user verification ML model, storing the training exemplars in a storage location that satisfies one or more defined security criteria.

Clause 18: A method according to any one of Clauses 13-17, further comprising using the second user verification ML model to process subsequent voice data.

Clause 19: A processing system, comprising: a memory comprising computer-executable instructions; one or more processors configured to execute the computer-executable instructions and cause the processing system to perform a method in accordance with any one of Clauses 1-18.

Clause 20: A processing system, comprising means for performing a method in accordance with any one of Clauses 1-18.

Clause 21: A non-transitory computer-readable medium comprising computer-executable instructions that, when executed by one or more processors of a processing system, cause the processing system to perform a method in accordance with any one of Clauses 1-18.

Clause 22: A computer program product embodied on a computer-readable storage medium comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for training a machine learning model for user verification, comprising:
receiving voice data from a first user;
in response to determining that the voice data includes an utterance of a defined keyword:
generating a user verification score by processing the voice data using a first user verification machine learning (ML) model; and
determining a quality of the voice data; and
in response to determining that the user verification score and determined quality satisfy one or more defined criteria, updating a second user verification ML model based on the voice data.

2. The computer-implemented method of claim 1, wherein:
determining that the voice data includes the utterance of the defined keyword comprises processing the voice data using a first keyword identification ML model,
the method further comprises confirming that the voice data includes the utterance of the defined keyword by processing the voice data using a second keyword identification ML model, and
the second keyword identification ML model is more accurate than the first keyword identification ML model.

3. The computer-implemented method of claim 1, wherein determining the quality of the voice data comprises at least one of:
determining a signal-to-noise (SNR) ratio of the voice data;
determining a clipping ratio of the voice data; or
determining a duration of the voice data.

4. The computer-implemented method of claim 1, further comprising storing the voice data as a training exemplar, wherein updating the second user verification ML model is performed based further in response to determining that a number of stored training exemplars satisfies one or more defined criteria.

5. The computer-implemented method of claim 4, further comprising, subsequent to updating the second user verification ML model, deleting the stored training exemplars.

6. The computer-implemented method of claim 4, further comprising, subsequent to updating the second user verification ML model, storing the training exemplars in a storage location that satisfies one or more defined security criteria.

7. The computer-implemented method of claim 1, further comprising using the second user verification ML model to process subsequent voice data.

8. The computer-implemented method of claim 1, wherein updating the second user verification ML model based on the voice data comprises:
extracting one or more features of the voice data;
labeling the one or more features of the voice data based on the user verification score; and
storing the one or more features and the label as a training exemplar.

9. The computer-implemented method of claim 8, wherein updating the second user verification ML model based on the voice data is performed based further in response to determining that a number of stored training exemplars satisfies one or more defined criteria, wherein the one or more defined criteria indicates at least one of:
a minimum number of stored positive exemplars corresponding to utterances made by a first user;
a minimum number of stored negative exemplars corresponding to utterances not made by the first user; or
a ratio of stored positive exemplars to stored negative exemplars.

10. The computer-implemented method of claim 8, wherein updating the second user verification ML model is performed using a federated learning operation.

11. The computer-implemented method of claim 10, wherein the federated learning operation comprises transmitting the training exemplar to a host system that performs the updating of the second user verification ML model.

12. The computer-implemented method of claim 10, wherein the federated learning operation comprises transmitting updated parameters of the second user verification ML model to a host system, wherein the host system aggregates updated parameters to update a global version of the second user verification ML model.

13. A computer-implemented method for performing user verification using machine learning, comprising:
receiving voice data from a first user;
in response to determining that the voice data includes an utterance of a defined keyword:
generating a user verification score by processing the voice data using a first user verification machine learning (ML) model; and
determining a quality of the voice data; and
in response to determining that the user verification score and determined quality satisfy one or more defined criteria, storing the voice data as a training exemplar.

14. The computer-implemented method of claim 13, wherein:
determining that the voice data includes the utterance of the defined keyword comprises processing the voice data using a first keyword identification ML model,
the method further comprises confirming that the voice data includes the utterance of the defined keyword by processing the voice data using a second keyword identification ML model, and
the second keyword identification ML model is more accurate than the first keyword identification ML model.

15. The computer-implemented method of claim 13, further comprising updating a second user verification ML model based further in response to determining that a number of stored training exemplars satisfies one or more defined criteria.

16. The computer-implemented method of claim 15, further comprising, subsequent to updating the second user verification ML model, deleting the stored training exemplars.

17. The computer-implemented method of claim 15, further comprising, subsequent to updating the second user verification ML model, storing the training exemplars in a storage location that satisfies one or more defined security criteria.

18. The computer-implemented method of claim 15, further comprising using the second user verification ML model to process subsequent voice data.

19. A processing system, comprising:
a memory comprising computer-executable instructions; and
one or more processors configured to execute the computer-executable instructions and cause the processing system to perform an operation comprising:
receiving voice data from a first user;
in response to determining that the voice data includes an utterance of a defined keyword:
generating a user verification score by processing the voice data using a first user verification machine learning (ML) model; and
determining a quality of the voice data; and
in response to determining that the user verification score and determined quality satisfy one or more defined criteria, updating a second user verification ML model based on the voice data.

20. The processing system of claim 19, wherein:
determining that the voice data includes the utterance of the defined keyword comprises processing the voice data using a first keyword identification ML model,
the operation further comprises confirming that the voice data includes the utterance of the defined keyword by processing the voice data using a second keyword identification ML model, and
the second keyword identification ML model is more accurate than the first keyword identification ML model.

21. The processing system of claim 19, wherein determining the quality of the voice data comprises at least one of:
determining a signal-to-noise (SNR) ratio of the voice data;
determining a clipping ratio of the voice data; or
determining a duration of the voice data.

22. The processing system of claim 19, the operation further comprising storing the voice data as a training exemplar, wherein updating the second user verification ML model is performed based further in response to determining that a number of stored training exemplars satisfies one or more defined criteria.

23. The processing system of claim 22, the operation further comprising, subsequent to updating the second user verification ML model, deleting the stored training exemplars.

24. The processing system of claim 22, the operation further comprising, subsequent to updating the second user verification ML model, storing the training exemplars in a storage location that satisfies one or more defined security criteria.

25. The processing system of claim 19, the operation further comprising using the second user verification ML model to process subsequent voice data.

26. The processing system of claim 19, wherein updating the second user verification ML model based on the voice data comprises:
extracting one or more features of the voice data;
labeling the one or more features of the voice data based on the user verification score; and
storing the one or more features and the label as a training exemplar.

27. The processing system of claim 26, wherein updating the second user verification ML model based on the voice data is performed based further in response to determining that a number of stored training exemplars satisfies one or more defined criteria, wherein the one or more defined criteria indicates at least one of:
a minimum number of stored positive exemplars corresponding to utterances made by a first user;
a minimum number of stored negative exemplars corresponding to utterances not made by the first user; or
a ratio of stored positive exemplars to stored negative exemplars.

28. The processing system of claim 26, wherein updating the second user verification ML model is performed using a federated learning operation.

29. The processing system of claim 28, wherein the federated learning operation comprises transmitting the training exemplar to a host system that performs the updating of the second user verification ML model.

30. A processing system, comprising:
means for receiving voice data from a first user;
means for, in response to determining that the voice data includes an utterance of a defined keyword:
generating a user verification score by processing the voice data using a first user verification machine learning (ML) model; and
determining a quality of the voice data; and
means for, in response to determining that the user verification score and determined quality satisfy one or more defined criteria, updating a second user verification ML model based on the voice data.
